(19) United States
(12) Patent Application Publication
(10) Pub. No.: US 2024/0353518 A1
(43) Pub. Date: Oct. 24, 2024

(54) SWITCHING POSITIONING STATE

(71) Applicant: Nokia Technologies Oy, Espoo (FI)

(72) Inventors: Oana-Elena BARBU, Aalborg (DK); Ryan KEATING, Naperville, IL (US)

(21) Appl. No.: 18/687,401

(22) PCT Filed: Sep. 20, 2021
(86) PCT No.: PCT/US2021/051055

§ 371 Date: Feb. 28, 2024

(51) Int. Cl. G01S 5/02; G01S 5/00

(52) U.S. Cl. CPC G01S 5/0236; G01S 5/0036; G01S 5/017

(57) ABSTRACT

Disclosed is a method comprising communicating, during a positioning session for positioning of a terminal device, at least one positioning signal in a first positioning state of at least two positioning states configured for the positioning session; switching from the first positioning state to a second positioning state of the at least two positioning states. wherein the first and second positioning states correspond to different reference signal configurations used for communicating of the at least one positioning signal; and communicating the at least one positioning signal in the second positioning state during the positioning session.

### FIELD

The following exemplary embodiments relate to wireless communication and to positioning.

### BACKGROUND

Positioning technologies may be used to estimate a physical location of a device. A high positioning accuracy may be desirable in order to estimate the location of the device more accurately. However, a high positioning accuracy may increase computational overhead at the device.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided an apparatus in a wireless communication network, the apparatus comprising at least one processor, and at least one memory including computer program code, wherein the at least one memory and the computer program code are configured, with the at least one processor, to cause the apparatus to: communicate, during a positioning session for positioning of the apparatus, at least one positioning signal in a first positioning state of at least two positioning states configured for the positioning session; switch from the first positioning state to a second positioning state of the at least two positioning states, wherein the first and second positioning states correspond to different reference signal configurations used for communicating of the at least one positioning signal; and communicate the at least one positioning signal in the second positioning state during the positioning session.

According to another aspect, there is provided an apparatus in a wireless communication network, the apparatus comprising means for: communicating, during a positioning session for positioning of the apparatus, at least one positioning signal in a first positioning state of at least two positioning states configured for the positioning session; switching from the first positioning state to a second positioning state of the at least two positioning states, wherein the first and second positioning states correspond to different reference signal configurations used for communicating of the at least one positioning signal; and communicating the at least one positioning signal in the second positioning state during the positioning session.

According to another aspect, there is provided a method comprising: communicating, during a positioning session for positioning of a terminal device, at least one positioning signal in a first positioning state of at least two positioning states configured for the positioning session; switching from the first positioning state to a second positioning state of the at least two positioning states, wherein the first and second positioning states correspond to different reference signal configurations used for communicating of the at least one positioning signal; and communicating the at least one positioning signal in the second positioning state during the positioning session.

According to another aspect, there is provided a computer program comprising instructions for causing an apparatus in a wireless communication network to perform at least the following: communicating, during a positioning session for positioning of the apparatus, at least one positioning signal in a first positioning state of at least two positioning states configured for the positioning session; switching from the first positioning state to a second positioning state of the at least two positioning states, wherein the first and second positioning states correspond to different reference signal configurations used for communicating of the at least one positioning signal; and communicating the at least one positioning signal in the second positioning state during the positioning session.

According to another aspect, there is provided a computer program product comprising program instructions which, when run on a computing apparatus in a wireless communication network, cause the computing apparatus to perform at least the following: communicating, during a positioning session for positioning of the computing apparatus, at least one positioning signal in a first positioning state of at least two positioning states configured for the positioning session; switching from the first positioning state to a second positioning state of the at least two positioning states, wherein the first and second positioning states correspond to different reference signal configurations used for communicating of the at least one positioning signal; and communicating the at least one positioning signal in the second positioning state during the positioning session.

According to another aspect, there is provided a computer readable medium comprising program instructions for causing an apparatus in a wireless communication network to perform at least the following: communicating, during a positioning session for positioning of the apparatus, at least one positioning signal in a first positioning state of at least two positioning states configured for the positioning session; switching from the first positioning state to a second positioning state of the at least two positioning states, wherein the first and second positioning states correspond to different reference signal configurations used for communicating of the at least one positioning signal; and communicating the at least one positioning signal in the second positioning state during the positioning session.

According to another aspect, there is provided a non-transitory computer readable medium comprising program instructions for causing an apparatus in a wireless communication network to perform at least the following: communicating, during a positioning session for positioning of the apparatus, at least one positioning signal in a first positioning state of at least two positioning states configured for the positioning session; switching from the first positioning state to a second positioning state of the at least two positioning states, wherein the first and second positioning states correspond to different reference signal configurations used for communicating of the at least one positioning signal; and communicating the at least one positioning signal in the second positioning state during the positioning session.

According to another aspect, there is provided an apparatus in a wireless communication network, the apparatus comprising at least one processor, and at least one memory including computer program code, wherein the at least one memory and the computer program code are configured, with the at least one processor, to cause the apparatus to: transmit, during a positioning session for positioning of a terminal device in the wireless communication network, to one or more network elements in the wireless communication network, an indication to communicate at least one positioning signal by switching from a first positioning state to a second positioning state of at least two positioning states configured for the positioning session, wherein the first and second positioning states correspond to different reference signal configurations used for communicating of the at least one positioning signal.

According to another aspect, there is provided an apparatus in a wireless communication network, the apparatus comprising means for: transmitting, during a positioning session for positioning of a terminal device in the wireless communication network, to one or more network elements in the wireless communication network, an indication to communicate at least one positioning signal by switching from a first positioning state to a second positioning state of at least two positioning states configured for the positioning session, wherein the first and second positioning states correspond to different reference signal configurations used for communicating of the at least one positioning signal.

According to another aspect, there is provided a method comprising: transmitting, during a positioning session for positioning of a terminal device in a wireless communication network, to one or more network elements in the wireless communication network, an indication to communicate at least one positioning signal by switching from a first positioning state to a second positioning state of at least two positioning states configured for the positioning session, wherein the first and second positioning states correspond to different reference signal configurations used for communicating of the at least one positioning signal.

According to another aspect, there is provided a computer program comprising instructions for causing an apparatus in a wireless communication network to perform at least the following: transmitting, during a positioning session for positioning of a terminal device in the wireless communication network, to one or more network elements in the wireless communication network, an indication to communicate at least one positioning signal by switching from a first positioning state to a second positioning state of at least two positioning states configured for the positioning session, wherein the first and second positioning states correspond to different reference signal configurations used for communicating of the at least one positioning signal.

According to another aspect, there is provided a computer program product comprising program instructions which, when run on a computing apparatus in a wireless communication network, cause the computing apparatus to perform at least the following: transmitting, during a positioning session for positioning of a terminal device in the wireless communication network, to one or more network elements in the wireless communication network, an indication to communicate at least one positioning signal by switching from a first positioning state to a second positioning state of at least two positioning states configured for the positioning session, wherein the first and second positioning states correspond to different reference signal configurations used for communicating of the at least one positioning signal.

According to another aspect, there is provided a computer readable medium comprising program instructions for causing an apparatus in a wireless communication network to perform at least the following: transmitting, during a positioning session for positioning of a terminal device in the wireless communication network, to one or more network elements in the wireless communication network, an indication to communicate at least one positioning signal by switching from a first positioning state to a second positioning state of at least two positioning states configured for the positioning session, wherein the first and second positioning states correspond to different reference signal configurations used for communicating of the at least one positioning signal.

According to another aspect, there is provided a non-transitory computer readable medium comprising program instructions for causing an apparatus in a wireless communication network to perform at least the following: transmitting, during a positioning session for positioning of a terminal device in the wireless communication network, to one or more network elements in the wireless communication network, an indication to communicate at least one positioning signal by switching from a first positioning state to a second positioning state of at least two positioning states configured for the positioning session, wherein the first and second positioning states correspond to different reference signal configurations used for communicating of the at least one positioning signal.

According to another aspect, there is provided a system comprising at least a terminal device and a network element of a wireless communication network. The network element is configured to: transmit, during a positioning session for positioning of the terminal device, at least to the terminal device, an indication to communicate at least one positioning signal by switching from a first positioning state to a second positioning state of at least two positioning states configured for the positioning session, wherein the first and second positioning states correspond to different reference signal configurations used for communicating of the at least one positioning signal. The terminal device is configured to: communicate, during the positioning session for positioning of the terminal device, the at least one positioning signal in the first positioning state; receive the indication from the network element; switch from the first positioning state to the second positioning state; and communicate the at least one positioning signal in the second positioning state during the positioning session.

According to another aspect, there is provided a system comprising at least a terminal device and a network element of a wireless communication network. The network element comprises means for: transmitting, during a positioning session for positioning of the terminal device, at least to the terminal device, an indication to communicate at least one positioning signal by switching from a first positioning state to a second positioning state of at least two positioning states configured for the positioning session, wherein the first and second positioning states correspond to different reference signal configurations used for communicating of the at least one positioning signal. The terminal device comprises means for: communicating, during the positioning session for positioning of the terminal device, the at least one positioning signal in the first positioning state; receiving the indication from the network element; switching from the first positioning state to the second positioning state; and communicating the at least one positioning signal in the second positioning state during the positioning session

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates a low overhead positioning example according to an exemplary embodiment;

FIGS. 3-10 illustrate signaling diagrams according to some exemplary embodiments;

FIGS. 11-12 illustrate flow charts according to some exemplary embodiments;

FIGS. 13-14 illustrate apparatuses according to some exemplary embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

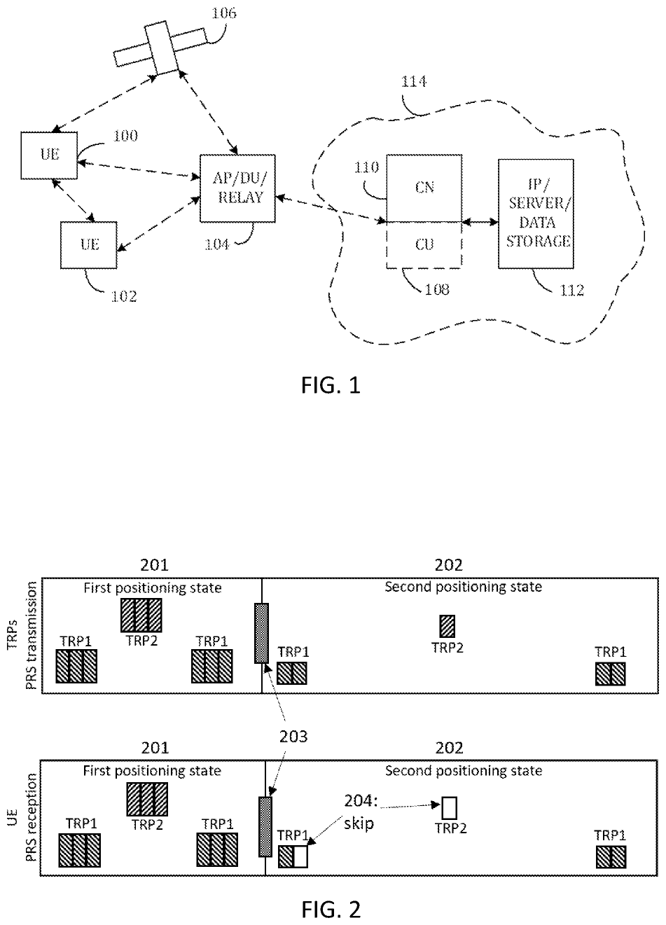

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB may be called uplink or reverse link and the physical link from the (e/g)NodeB to the user device may be called downlink or forward link. It should be appreciated that (e/g)NodeBs or their functionalities may be implemented by using any node, host, server or access point etc. entity suitable for such a usage.

A communication system may comprise more than one (e/g)NodeB, in which case the (e/g)NodeBs may also be configured to communicate with one another over links, wired or wireless, designed for the purpose. These links may be used for signaling purposes. The (e/g)NodeB may be a computing device configured to control the radio resources of communication system it is coupled to. The (e/g)NodeB may also be referred to as a base station, an access point or any other type of interfacing device including a relay station capable of operating in a wireless environment. The (e/g)NodeB may include or be coupled to transceivers. From the transceivers of the (e/g)NodeB, a connection may be provided to an antenna unit that establishes bi-directional radio links to user devices. The antenna unit may comprise a plurality of antennas or antenna elements. The (e/g)NodeB may further be connected to core network 110 (CN or next generation core NGC). Depending on the system, the counterpart on the CN side may be a serving gateway (S-GW, routing and forwarding user data packets), packet data network gateway (P-GW), for providing connectivity of user devices (UEs) to external packet data networks, mobility management entity (MME), or location management function (LMF), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and UE(s) and/or between the IAB node and other IAB nodes (multi-hop scenario).

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may also comprise other apparatuses, such as physical layer relay nodes or other network elements, etc. At least one of the (e/g)NodeBs or may be a Home (e/g)nodeB.

Furthermore, the (e/g)nodeB or base station may also be split into: a radio unit (RU) comprising a radio transceiver (TRX), i.e., a transmitter (TX) and a receiver (RX); one or more distributed units (DUs) that may be used for the so-called Layer 1 (L1) processing and real-time Layer 2 (L2) processing; and a central unit (CU) or a centralized unit that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the (e/g)nodeB or base station. The DU may be defined as a logical node hosting radio link control (RLC), medium access control (MAC) and/or physical (PHY) layers of the (e/g)nodeB or base station. The operation of the DU may be at least partly controlled by the CU. The CU may comprise a control plane (CU-CP), which may be defined as a logical node hosting the RRC and the control plane part of the PDCP protocol of the CU for the (e/g)nodeB or base station. The CU may further comprise a user plane (CU-UP), which may be defined as a logical node hosting the user plane part of the PDCP protocol and the SDAP protocol of the CU for the (e/g)nodeB or base station.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In multilayer networks, one access node may provide one kind of a cell or cells, and thus a plurality of (e/g)NodeBs may be needed to provide such a network structure.

For fulfilling the need for improving the deployment and performance of communication systems, the concept of “plug-and-play” (e/g)NodeBs may be introduced. A network which may be able to use “plug-and-play” (e/g)NodeBs, may include, in addition to Home (e/g)NodeBs (H (e/g)nodeBs), a home node B gateway, or HNB-GW (not shown in FIG. 1). A HNB Gateway (HNB-GW), which may be installed within an operator's network, may aggregate traffic from a large number of HNBs back to a core network.

In asset tracking solutions, small amounts of data may be transmitted periodically from a sensor to the cloud to be stored and analyzed. Based on the analyzing, action may be taken in order to optimize the use of the asset, or equipment, that the sensor is measuring. Asset tracking may be used, for example, to track the location and temperature of industrial equipment or shipping containers, to monitor a water or gas meter to determine usage, or to track the status of a streetlight or a parking space. (It should be appreciated that the above list is a non-limiting list of examples of use cases for asset tracking.) The benefits of using 5G for asset tracking connectivity include low-power sensors with long battery lives, and improved coverage compared to LTE. In addition, LTE networks are forward compatible with 5G.

Low-complexity devices, such as reduced capability (RedCap) devices and IoT devices, may be used as asset-tracking devices (e.g., as cloud-connected sensors). One of the goals of asset tracking may be to accurately provide the location of asset-tracking devices, and to provide a solution that works globally and covers diverse scenarios, such as remote rural areas, urban outdoor areas, as well as indoor areas (e.g., homes, offices, and factories).

The requirements for asset tracking positioning accuracy (horizontal and vertical) may vary. For example, a lower positioning accuracy may be sufficient for assets that are moving on highways or at sea, while assets in denser areas, such as factories, storage facilities, or delivery facilities, may require a higher positioning accuracy. In addition, a certain minimum amount of power may be needed for the device to position itself, or to be positioned by the network, and thus be able to perform a full positioning session while in RRC inactive or idle state. The requirements may also include low latency, network efficiency (scalability, reference signal overhead, etc.), and device efficiency (power consumption, complexity, etc.).

There is a challenge in how to provide accurate positioning for low-complexity devices, such as RedCap devices and IoT devices, which may serve as asset-tracking devices.

RedCap devices may have lower complexity (e.g., reduced bandwidth and number of antennas), a longer battery life, and a smaller form factor than high-end NR UEs, such as enhanced mobile broadband (eMBB) and ultra-reliable low latency communication (URLLC) devices. For example, a RedCap device may comprise 1 receiver branch and 1 transmitter branch (1RX/1TX), or 2 receiver branches and 1 transmitter branch (2RX/1TX), in both frequency range 1 (FR1) and frequency range 2 (FR2). RedCap devices may support all FR1 and FR2 bands for frequency-division duplexing (FDD) and time-division duplexing (TDD). Some examples of RedCap devices are industrial wireless sensors, video surveillance cameras, and wearables (e.g., smart watches, rings, eHealth-related devices, personal protection equipment, medical monitoring devices, etc.). RedCap devices may also be referred to as NR-Lite devices or NR-Light devices.

The positioning reference signal (PRS) and sounding reference signal for positioning (SRS-P) may be used as positioning signals for estimating the location of the asset-tracking device. PRS is a reference signal for positioning in the downlink (DL). SRS-P is a reference signal for positioning in the uplink (UL). These reference signals may be considered to be wideband in order to enable high timing resolution of positioning measurements.

The transmission and reception of positioning signal such as SRS-P or PRS may be configured by the network with a periodic time pattern, as well as fixed repetition and density rates. The location management function (LMF) may configure the positioning signal transmission with the following: 1) a periodicity (P), i.e., the number of subframes after which the signal should be retransmitted, 2) a repetition rate (R), i.e., the number of consecutive symbols occupied by a positioning signal, and/or 3) a comb pattern (C), i.e., the frequency density of physical resource blocks (PRBs), or subcarriers, for positioning.

A positioning transmitter, i.e., a UE for UL SRS, or a transmission and reception point (TRP) at the network side for DL PRS, may periodically transmit positioning signals, and the receiver then detects and measures these signals periodically. The TRP may refer to any signal source, for example a network node or a remote radio head (RRH), which has the capability to transmit a PRS. For UEs that are static, or moving at slow speed, or on a pre-defined trajectory, etc., such a scheme may result in a high resource overhead, as well as a high computational overhead for the positioning receiver. The high resource overhead may be due to overprovisioning of TX resources, and due to reporting unnecessary positioning measurements. The high computational overhead may be caused by the fact that the positioning receiver may remain connected or wake up frequently in order to periodically measure the positioning signal, just to detect that the channel conditions have remained unchanged since the previous positioning session.

For low-complexity devices, such as asset-tracking devices, this high resource overhead and computational overhead may result in a too large overhead in terms of spectral efficiency and power consumption. Thus, there is a need to reduce the overhead for asset-tracking devices.

Some exemplary embodiments enable a flexible positioning session that allows the UE (e.g., a low-complexity device serving as an asset-tracking device) to switch among multiple positioning states as a trade-off between power consumption and accuracy in order to reduce resource overhead. At the network side, some exemplary embodiments may reduce PRB usage for the PRS transmission and associated reporting. At the UE side, some exemplary embodiments may reduce the UE complexity and power consumption for processing positioning signals, when the UE remains in static or semi-static conditions for a certain period of time. Some exemplary embodiments may be applied to UEs in RRC connected state, RRC inactive state, or RRC idle state.

Some exemplary embodiments may utilize a multi-state configuration comprising at least two positioning states. For example, the multi-state configuration may comprise at least a first positioning state called “position_fix”, and a second positioning state called “position_tracking”. The multi-state configuration may be realized, for example, via LTE positioning protocol (LPP) assistance data, or RRC configuration and new radio positioning protocol A (NRPPa) messaging, respectively.

The multi-state configuration may comprise the configuration of each of the possible positioning states, wherein a positioning state defines at least the positioning signal transmissions, and/or reception and reporting of the positioning signal. For example, a given positioning state definition may configure at least: the SRS-P or PRS (time, frequency, space, periodicity, code, TRP identifier) transmission and the minimal receive configuration for measurement. The receive configuration may comprise, for example, a number of samples per SRS-P or PRS, and one or more positioning metrics.

The multi-state configuration may further comprise a definition of a state-switch trigger, which indicates when the involved entities should switch from one positioning state to another. Such a state-switch trigger may be explicit and generated by the LMF, UE or serving gNB, or implicit based on the result of an internal evaluation by the UE or network of mutually agreed positioning metrics. The explicit state-switch trigger may be a direct command to switch between states (e.g., LMF indicates the UE to move from state X to state Y).

The target UE and TRP(s) may initiate the positioning session corresponding to the first signalled positioning state, as configured in the multi-state configuration. The conclusion of the current positioning state may be realized by analyzing and implementing the type of the state-switch trigger configured in the multi-state configuration.

If the LMF generates the explicit state-switch trigger, then the LMF informs the serving gNB, the rest of the TRPs, and the UE for example via NRPPa and/or LPP. For example, the trigger may be transparent to the serving gNB, or the serving gNB may forward the trigger to the UE after obtaining it from the LMF.

Alternatively, if the serving gNB generates the explicit state-switch trigger, then the trigger may be propagated to the UE and LMF via RRC or MAC control element (MAC CE), and NRPPa, respectively. For example, the serving gNB may evaluate the mobility of the UE and determine that another positioning state fits the UE's current mobility status better.

Alternatively, if the UE generates the explicit state-switch trigger, then the UE may inform the LMF and the serving gNB (in case the new state has implications on the measurement gap reconfiguration) via LPP and RRC, respectively. Alternatively, the trigger may be transparent to the serving gNB and sent directly to the LMF over LPP.

In case of an implicit trigger, the UE or network may autonomously determine that the state has changed based on the corresponding behavior of the UE.

FIG. 2 illustrates a low overhead positioning example according to an exemplary embodiment. In other words, FIG. 2 illustrates the usage of a state-switch trigger and its impact on the subsequent PRS transmission and reception. In this example, the LMF configures a target UE and a set of TRPs with a multi-state positioning session.

Referring to FIG. 2, the UE and TRPs are configured with two positioning states: a first positioning state 201 called “position_fix”, and a second positioning state 202 called “position_tracking”. For example, the “position_fix” state may be triggered when the UE is localized for the first time, or when the required location accuracy is very high. On the other hand, the “position_tracking” state may deploy a more relaxed positioning session, where the LMF has some information about the UE trajectory, speed, and/or past locations, and can locate the UE with a smaller number of instantaneous measurements.

In the “position_fix” state 201, the PRS transmission is dense in both time and frequency, and the UE measures all of the involved TRPs (TRP1 and TRP2 in this example) and requests multiple measurement gaps in order to change carriers for measuring the different TRPs. Upon finalization of the “position_fix” sub-session, in step 203 the UE evaluates the positioning metrics for a state change and generates an explicit state-switch trigger message. The message reaches the TRPs, for example via LMF. Upon reception of the state-switch trigger message, the TRPs reconfigure their PRS transmission to switch the transmission of the PRS to the “position_tracking” state 202, i.e., less dense PRS transmission in time and frequency compared to the “position_fix” state. In other words, the PRS transmission may utilize less radio resources in the “position_tracking” state compared to the “position_fix” state. Similarly, the UE also reconfigures its PRS reception to match the new state configuration. In the “position_tracking” state, the UE may skip 204 one or more measurements. For example, the UE may skip measuring TRP2 in the “position_tracking” state, and listen for PRS for a shorter period.

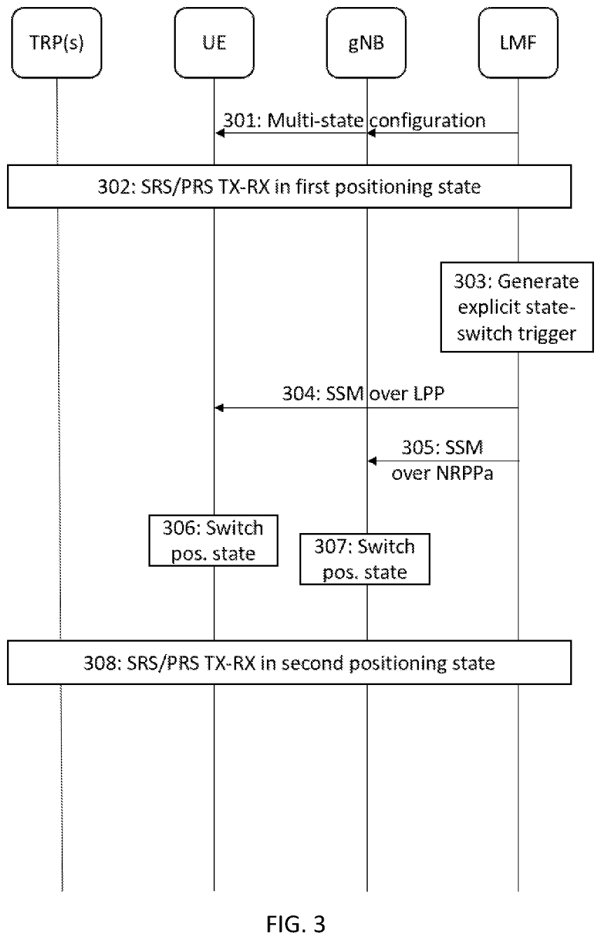

FIG. 3 illustrates a signaling diagram for a positioning session according to an exemplary embodiment, wherein an LMF generates an explicit state-switch trigger and signals it over LPP and NRPPa.

Referring to FIG. 3, in step 301, the LMF transmits, to a UE, a message indicative of a multi-state configuration for pre-configuring a multi-state positioning session, wherein multi-state refers to the various alternatives (i.e., states) of how the positioning signals (PRS in DL and SRS-P in UL) can be transmitted over the wireless channel, or received and measured by the positioning receiver. The UE may be, for example, an asset-tracking device. The LMF may also transmit the multi-state configuration to the serving base station (e.g., gNB) of the UE over an NRPPa interface. The LMF may transmit the multi-state configuration to the UE directly over an LPP interface, or via the gNB by using the NRPPa interface between the LMF and the gNB.

For example, the LMF may configure at least two different positioning states in the multi-state configuration: a first positioning state called “position_fix”, and a second positioning state called “position_tracking”. The multi-state configuration may define one or more conditions for switching between positioning states. For example, in this exemplary embodiment, the one or more conditions may be fulfilled by receiving an explicit state-switch trigger from the LMF. The explicit state-switch trigger may also be referred to as an indication to switch the positioning state.

The “position_fix” state may be activated, when the UE is first localized, or for high accuracy and/or low latency positioning, for example for an industrial internet of things (IIot) use case. The “position_fix” state may utilize a dense positioning signal allocation in the time, frequency and space domains, a high repetition rate, and low periodicity of such signals. Similarly, at reception, the “position_fix” state may utilize exhaustive signal acquisition in time, frequency and space dimensions, and advanced processing for precise measurement extraction, etc.

The “position_tracking” state may utilize a more relaxed positioning signal configuration, for example less repetitions, a higher periodicity, a smaller bandwidth, a larger comb pattern, and/or less TRPs, etc., compared to the “position_fix” state. The “position_tracking” state may be triggered after an initial position fix has been acquired, if the UE is stationary or in RRC idle or inactive state, and/or for UEs with less stringent quality of service (QOS) positioning requirements, and/or for low-power devices (e.g., asset-tracking devices). Similarly, the reception of the signal may happen in an opportunistic (UE-led) way. For example, the UE may autonomously decide: 1) to not measure all TRPs, if measuring all TRPs would require the reconfiguration of a measurement gap, and/or 2) to terminate the signal detection early, for example collect a limited number of samples in the time and space domains by decreasing the sampling rate and/or by using wider beamforming, respectively.

It should be noted that the multi-state configuration may also comprise more than two positioning states, i.e., state 1, . . . , state N, wherein the states may have different degrees of complexity, latency, and/or accuracy. The multi-state configuration may comprise a multi-state transmitter (TX) configuration that defines the positioning signal transmission in a given positioning state, and/or a multi-state receiver (RX) configuration that defines the minimum requirements, for example the minimum observation time window, for the signal measurement upon reception of the positioning signal in a given positioning state.

In step 302, the UE and the serving base station (e.g., gNB) may perform SRS-P or PRS transmission, reception and reporting in the first positioning state, i.e., the “position_fix” state. For example, the UE may transmit an SRS-P to the gNB in the uplink according to the configuration of the first positioning state, and the gNB may then receive and measure the received SRS-P according to the configuration of the first positioning state. Alternatively, the gNB may transmit a PRS to the UE in the downlink via one or more TRPs according to the configuration of the first positioning state, and the UE may then receive and measure the received PRS and report the measurements to the gNB according to the configuration of the first positioning state.

In step 303, the LMF generates an explicit state-switch trigger. For generating the state-switch trigger at the LMF side, the LMF may collect channel quality indicators associated with the UE from the serving gNB in order to determine whether the mobility status of the UE has changed (e.g., a formerly static UE has started moving). The LMF may determine to generate the state-switch trigger based on a change in, for example, one or more of the following positioning metrics: reference signal received power (RSRP), received signal strength indicator (RSSI), channel quality indicator (CQI), serving beam index, timing advance (TA), and/or maximum Doppler shift estimate at the serving gNB. Any of these positioning metrics, or any combination of two or more of these positioning metrics, may be reported to the LMF, which (in this exemplary embodiment) is in charge of determining a state transition from a current positioning state to a new positioning state.

For example, the LMF may determine, based on a large RSRP variation, that the UE has started moving (i.e., the mobility status of the UE has changed). Then, using the QoS requirements of the UE, and the last known position fix of the UE, the LMF may trigger a positioning state switch via a state-switch message (SSM), which comprises at least the index of the positioning state to switch to. The indices may be defined in the multi-state configuration. As a non-limiting example, an index ‘0’ may indicate the first positioning state, an index ‘1’ may indicate the second positioning state, and so on. The QoS requirements may comprise, for example, one or more positioning requirements such as target latency, and/or target positioning accuracy. A non-limiting example of the target latency is 10 ms for IIoT, or 100 ms in other use cases. A non-limiting example of the target positioning accuracy is 30-50 cm.

In step 304, the LMF transmits the SSM to the target UE via LPP signaling. In step 305, the LMF transmits the SSM to the selected one or more TRPs of the gNB via NRPPa signaling.

In step 306, the UE switches to the positioning state indicated by the positioning state index comprised in the received SSM. In step 307, the gNB switches to the positioning state indicated by the positioning state index comprised in the received SSM. For example, the UE and the gNB may switch to the second positioning state, i.e., the “position_tracking” state.

In step 308, the UE and the gNB may perform SRS-P or PRS transmission, reception and reporting in the second positioning state, i.e., the “position_tracking” state. For example, the UE may transmit SRS-P to the gNB in the uplink according to the configuration of the second positioning state, and the gNB may then measure the received SRS-P according to the configuration of the second positioning state. Alternatively, the gNB may transmit PRS to the UE in the downlink according to the configuration of the second positioning state, and the UE may then measure the received PRS and report the measurements to the gNB according to the configuration of the second positioning state.

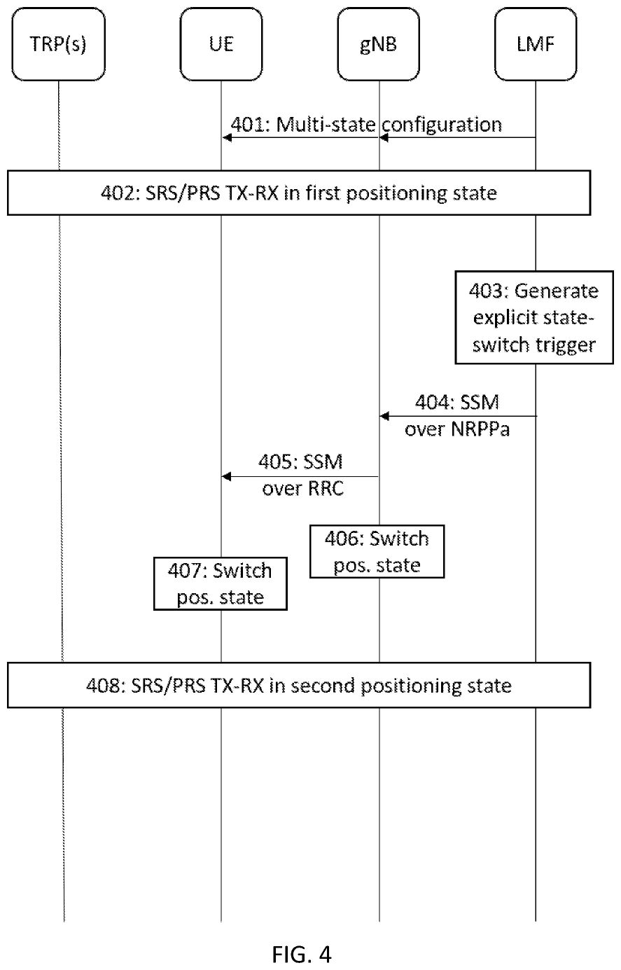

FIG. 4 illustrates a signaling diagram for a positioning session according to another exemplary embodiment, wherein an LMF generates an explicit state-switch trigger and signals it over NRPPa and RRC (i.e., the serving gNB forwards the state-switch trigger from the LMF to the UE).

Referring to FIG. 4, in step 401, the LMF transmits, to a UE, a message indicative of a multi-state configuration for pre-configuring a multi-state positioning session, wherein multi-state refers to the various alternatives (i.e., states) of how the positioning signals (PRS in DL and SRS-P in UL) can be transmitted over the wireless channel, or received and measured by the positioning receiver. The UE may be, for example, an asset-tracking device. The LMF may also transmit the multi-state configuration to the serving base station (e.g., gNB) of the UE.

For example, the LMF may configure at least two different positioning states in the multi-state configuration: a first positioning state called “position_fix”, and a second positioning state called “position_tracking”. The multi-state configuration may define one or more conditions for switching between positioning states. For example, in this exemplary embodiment, the one or more conditions may be fulfilled by receiving an explicit state-switch trigger. The explicit state-switch trigger may also be referred to as an indication to switch the positioning state.

In step 402, the UE and the serving base station (e.g., gNB) may perform SRS-P or PRS transmission, reception and reporting in the first positioning state, i.e., the “position_fix” state. For example, the UE may transmit an SRS-P to the gNB in the uplink according to the configuration of the first positioning state, and the gNB may then measure the received SRS-P according to the configuration of the first positioning state. Alternatively, the gNB may transmit a PRS to the UE in the downlink via one or more TRPs according to the configuration of the first positioning state, and the UE may then measure the received PRS and report the measurements to the gNB according to the configuration of the first positioning state.

In step 403, the LMF generates an explicit state-switch trigger. For example, the LMF may determine, based on a large RSRP variation, that the UE has started moving (i.e., the mobility status of the UE has changed). Then, using the QoS requirements of the UE, and the last known position fix of the UE, the LMF may trigger a positioning state switch via SSM, which comprises at least the index of the positioning state to switch to. For example, the SSM may comprise an index associated with the second positioning state, i.e., the “position_tracking” state.

The LMF transmits the SSM to the UE via the gNB. In other words, in step 404 the LMF transmits the SSM to the gNB as an NRPPa message, and in step 405 the gNB transmits, or forwards, the SSM to the UE as an RRC message.

In step 406, the gNB may switch to the positioning state indicated by the positioning state index comprised in the received SSM. In step 407, the UE switches to the positioning state indicated by the positioning state index comprised in the received SSM. For example, the UE and the gNB may switch to the second positioning state, i.e., the “position_tracking” state.

In step 408, the UE and the gNB may perform SRS-P or PRS transmission, reception and reporting in the second positioning state, i.e., the “position_tracking” state. For example, the UE may transmit SRS-P to the gNB in the uplink according to the configuration of the second positioning state, and the gNB may then measure the received SRS-P according to the configuration of the second positioning state. Alternatively, the gNB may transmit PRS to the UE in the downlink according to the configuration of the second positioning state, and the UE may then measure the received PRS and report the measurements to the gNB according to the configuration of the second positioning state.

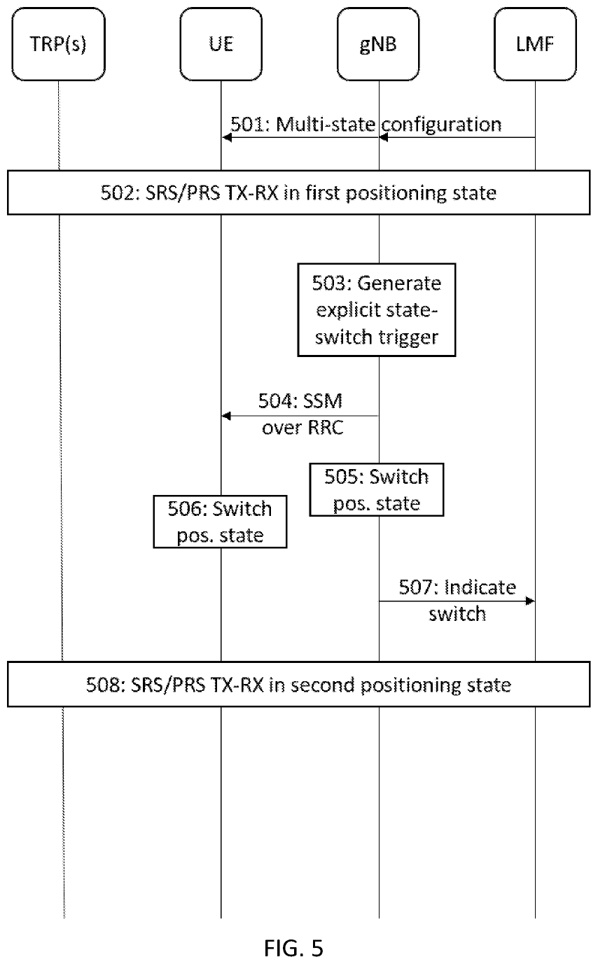

FIG. 5 illustrates a signaling diagram for a positioning session according to another exemplary embodiment, wherein the gNB triggers an explicit positioning state switch and indicates the state switch directly to the UE for example via RRC or MAC CE. The gNB may also inform the LMF of the state switch for example via NRPPa.

Referring to FIG. 5, in step 501, the LMF transmits, to a UE, a message indicative of a multi-state configuration for pre-configuring a multi-state positioning session, wherein multi-state refers to the various alternatives (i.e., states) of how the positioning signals (PRS in DL and SRS-P in UL) can be transmitted over the wireless channel, or received and measured by the positioning receiver. The UE may be, for example, an asset-tracking device. The LMF may also transmit the multi-state configuration to the serving base station (e.g., gNB) of the UE.

For example, the LMF may configure at least two different positioning states in the multi-state configuration: a first positioning state called “position_fix”, and a second positioning state called “position_tracking”. The multi-state configuration may define one or more conditions for switching between positioning states. For example, in this exemplary embodiment, the one or more conditions may be fulfilled by receiving an explicit state-switch trigger from the serving base station (e.g., gNB). The explicit state-switch trigger may also be referred to as an indication to switch the positioning state.

In step 502, the UE and the serving gNB may perform SRS-P or PRS transmission, reception and reporting in the first positioning state, i.e., the “position_fix” state. For example, the UE may transmit an SRS-P to the gNB in the uplink according to the configuration of the first positioning state, and the gNB may then measure the received SRS-P according to the configuration of the first positioning state. Alternatively, the gNB may transmit a PRS to the UE in the downlink via one or more TRPs according to the configuration of the first positioning state, and the UE may then measure the received PRS and report the measurements to the gNB according to the configuration of the first positioning state.

In step 503, the gNB generates an explicit positioning state switch trigger. For example, the gNB may be monitoring the UE mobility, and determine, based on a large RSRP variation, that the UE has started moving (i.e., the mobility status of the UE has changed). Then, using the QoS requirements of the target UE, and the last known position fix of the UE, the gNB may trigger a positioning state change via an SSM transmitted to the UE via RRC or MAC CE. For example, the SSM may comprise an index associated with the second positioning state, i.e., the “position_tracking” state.

In step 504, the gNB transmits the SSM to the UE in an RRC message or in a MAC CE.

In step 505, the gNB may switch to the positioning state indicated by the positioning state index comprised in the SSM. In step 506, the UE switches to the positioning state indicated by the positioning state index comprised in the received SSM. For example, the UE and the gNB may switch to the second positioning state, i.e., the “position_tracking” state.

In step 507, the gNB may indicate the positioning state switch to the LMF in an NRPPa message. In other words, the gNB may inform the LMF of the positioning switch.

In step 508, the UE and the gNB may perform SRS-P or PRS transmission, reception and reporting in the second positioning state, i.e., the “position_tracking” state. For example, the UE may transmit SRS-P to the gNB in the uplink according to the configuration of the second positioning state, and the gNB may then measure the received SRS-P according to the configuration of the second positioning state. Alternatively, the gNB may transmit PRS to the UE in the downlink according to the configuration of the second positioning state, and the UE may then measure the received PRS and report the measurements to the gNB according to the configuration of the second positioning state.

In another exemplary embodiment, if the state-switch trigger is generated at the receiver side, i.e., the UE in DL or the base station in UL, then the receiver may inform the LMF, via an intermediate request (via LPP in DL positioning or NRPPa in UL positioning), about the state it wishes to switch to. This request may be referred to as a state-switch intermediate request (SSIR) herein. In case of DL positioning, the SSIR may be transmitted by the UE via the LPP interface to the LMF, and/or over RRC to the serving base station in order for the serving base station to implement the associated reconfigurations related to, for example, measurement gap. The serving base station may forward the SSIR to the LMF for example via NRPPa.

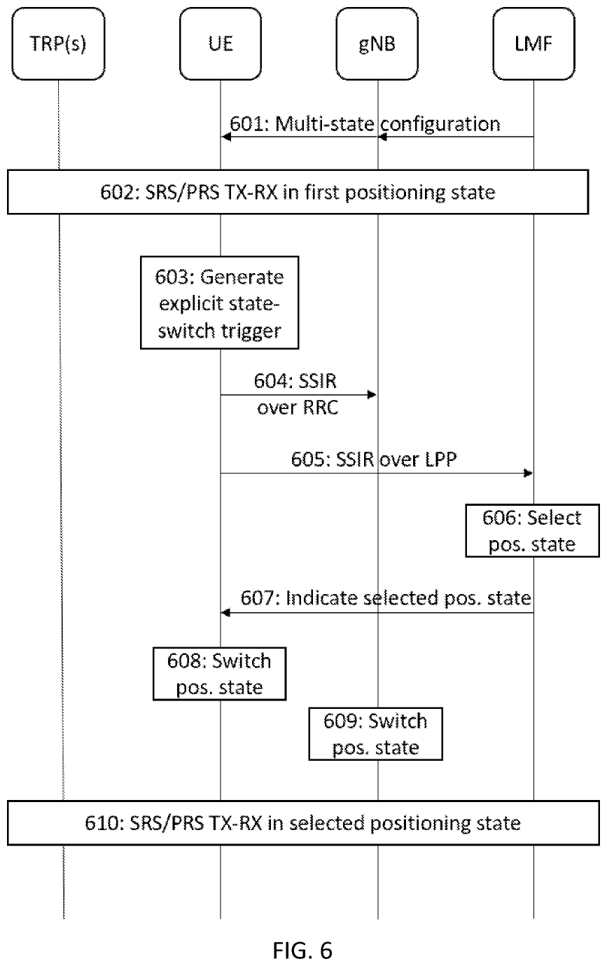

FIG. 6 illustrates a signaling diagram for a positioning session according to an exemplary embodiment, wherein a UE generates an explicit state-switch trigger and signals it over RRC and LPP. In other words, the UE is the receiver of the positioning signal in this case.

Referring to FIG. 6, in step 601, the LMF transmits, to a UE, a message indicative of a multi-state configuration for pre-configuring a multi-state positioning session, wherein multi-state refers to the various alternatives (i.e., states) of how the positioning signal (e.g. PRS in DL) can be transmitted over the wireless channel, and/or received and measured by the positioning receiver. The UE may be, for example, an asset-tracking device. The LMF may also transmit the multi-state configuration to the serving base station (e.g., gNB) of the UE. The serving base station is the transmitter of the positioning signal in this case.

For example, the LMF may configure at least two different positioning states in the multi-state configuration: a first positioning state called “position_fix”, and a second positioning state called “position_tracking”. The multi-state configuration may define one or more conditions for switching between positioning states. For example, in this exemplary embodiment, the one or more conditions may be fulfilled, when RSRP variation is above a first threshold, and/or TA variation is above a second threshold. The multi-state configuration may further indicate the UE to request and implement a positioning state switch, when the one or more conditions are fulfilled.

In step 602, the UE and the serving gNB may perform SRS-P or PRS transmission, reception and reporting in the first positioning state, i.e., the “position_fix” state. For example, the gNB may transmit PRS to the UE in the downlink according to the configuration of the first positioning state, and/or the UE may measure the received PRS and report the measurements to the gNB according to the configuration of the first positioning state.

In step 603, the UE generates an explicit positioning state switch trigger, if the one or more conditions are fulfilled.

In step 604, the UE may transmit an SSIR to the gNB in an RRC message. In step 605, the UE transmits the SSIR to the LMF in an LPP message. The SSIR may comprise a preferred state index, or a set of multiple preferred states indices ordered by priority. For example, the SSIR may comprise at least an index associated with the second positioning state (i.e., the “position_tracking” state) in order to request a switch to the second positioning state. The SSIR may comprise a request for a full-state transition (i.e., switching the positioning state at both the transmitter and receiver) or a semi-state transition (i.e., switching the positioning state at the receiver, but not at the transmitter).

In step 606, in case the SSIR contains an ordered set of preferred state indices, the LMF may assess the request, and select one state from the set of preferred indices.

In step 607, the LMF may inform the UE about the result by indicating the selected positioning state to the UE in an LPP message. The LMF may also indicate the selected positioning state to the gNB. Alternatively, if the SSIR comprises a single preferred state index, then the LMF may indicate a confirmation or rejection of the requested positioning state switch to the UE and/or the gNB in step 607. For example, the LMF may reject the positioning state switch, if the LMF determines that the UE cannot support it due to UE battery limitations. By rejecting the positioning state switch, the LMF may force the UE and/or the gNB to maintain the current positioning state (i.e., no switch is performed in case of rejection).

In step 608, the UE switches to the positioning state indicated by the LMF and/or the SSIR. In step 609, the gNB may switch to the positioning state indicated by the LMF and/or the SSIR.

If the UE requests a full-state transition in the SSIR, then both the transmission and reception of the positioning signal (i.e., both the UE and the gNB) may switch to the configuration associated with the selected positioning state. This situation may occur, for example, if the UE has concluded that the bandwidth may be reduced, or the sampling rate of the measurements needs to be increased or decreased.

If the UE requests a semi-state transition in the SSIR, then the measurement acquisition at the receiver side (i.e., at the UE in this case) is switched to the selected positioning state, but the configuration at the transmitter side (i.e., at the gNB in this case) does not need to be changed. In this case, the transmission is not necessarily affected, but the LMF needs to be aware that the measurement quality is changing, and that the LPP report periodicity and size may also change. For example, when the receiver is the UE (i.e., in DL positioning), the UE may decide (in step 603) to adopt a positioning state, in which it listens to and measures every other PRS transmission, and thus the reporting frequency (rate) is halved. Similarly, the UE may skip any measurement that requires a measurement gap, and thus the payload of the report may decrease. Conversely, the UE may increase the periodicity of the measurement gap, and measure fewer frequency layers.

In step 610, the UE and/or the gNB may perform SRS-P or PRS transmission, reception and reporting in the selected positioning state, for example the second positioning state (the “position_tracking” state). For example, the gNB may transmit PRS to the UE in the downlink according to the configuration of the selected positioning state, and/or the UE may measure the received PRS and report the measurements to the gNB according to the configuration of the selected positioning state.

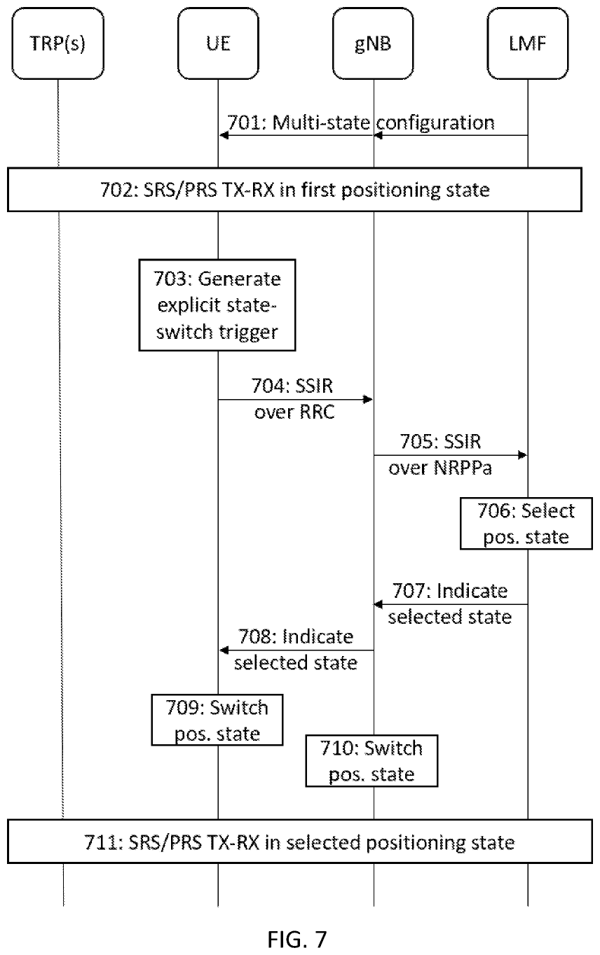

FIG. 7 illustrates a signaling diagram for a positioning session according to another exemplary embodiment, wherein a UE generates an explicit state-switch trigger and signals it over RRC and NRPPa. In other words, the UE is the receiver of the positioning signal in this case.

Referring to FIG. 7, in step 701, the LMF transmits, to a UE, a message indicative of a multi-state configuration for pre-configuring a multi-state positioning session, wherein multi-state refers to the various alternatives (i.e., states) of how the positioning signal (e.g., PRS in DL) can be transmitted over the wireless channel, and/or received and measured by the positioning receiver. The UE may be, for example, an asset-tracking device. The LMF may also transmit the multi-state configuration to the serving base station (e.g., gNB) of the UE. The serving base station is the transmitter of the positioning signal in this case.

For example, the LMF may configure at least two different positioning states in the multi-state configuration: a first positioning state called “position_fix”, and a second positioning state called “position_tracking”. The multi-state configuration may define one or more conditions for switching between positioning states. For example, in this exemplary embodiment, the one or more conditions may be fulfilled, when RSRP variation is above a first threshold, and/or TA variation is above a second threshold. The multi-state configuration may further indicate the UE to request and implement a positioning state switch, when the one or more conditions are fulfilled.

In step 702, the UE and the serving gNB may perform SRS-P or PRS transmission, reception and reporting in the first positioning state, i.e., the “position_fix” state. For example, the gNB may transmit PRS to the UE in the downlink according to the configuration of the first positioning state, and/or the UE may measure the received PRS and report the measurements to the gNB according to the configuration of the first positioning state.

In step 703, the UE generates an explicit positioning state switch trigger, if the one or more conditions are fulfilled.

In step 704, the UE transmits an SSIR to the gNB in an RRC message. In step 705, the gNB transmits, or forwards, the SSIR to the LMF in an NRPPa message. The SSIR may comprise a preferred state index, or a set of multiple preferred states indices ordered by priority. For example, the SSIR may comprise at least an index associated with the second positioning state (i.e., the “position_tracking” state) in order to request a switch to the second positioning state. The SSIR may comprise a request for a full-state transition (i.e., switching the positioning state at both the transmitter and receiver) or a semi-state transition (i.e., switching the positioning state at the receiver, but not at the transmitter).

In step 706, in case the SSIR contains an ordered set of preferred state indices, the LMF may assess the request, and select one state from the set of preferred indices. In step 707, the LMF indicates the selected positioning state to the gNB via NRPPa. In step 708, the gNB indicates the selected positioning state to the UE via RRC or MAC CE. In other words, the LMF indicates the selected positioning state to the UE via the gNB.

In step 709, the UE switches to the positioning state indicated by the LMF and/or the SSIR. In step 710, the gNB may switch to the positioning state indicated by the LMF and/or the SSIR. If the UE requests a full-state transition in the SSIR, then both the transmission and reception of the positioning signal (i.e., both the UE and the gNB) may switch to the configuration associated with the selected positioning state. If the UE requests a semi-state transition in the SSIR, then the measurement acquisition at the receiver side (i.e., at the UE in this case) is switched to the selected positioning state, but the configuration at the transmitter side (i.e., at the gNB in this case) does not need to be changed.

In step 711, the UE and/or the gNB may perform SRS-P or PRS transmission, reception and reporting in the selected positioning state, for example the second positioning state (the “position_tracking” state). For example, the gNB may transmit PRS to the UE in the downlink according to the configuration of the selected positioning state, and/or the UE may measure the received PRS and report the measurements to the gNB according to the configuration of the selected positioning state.

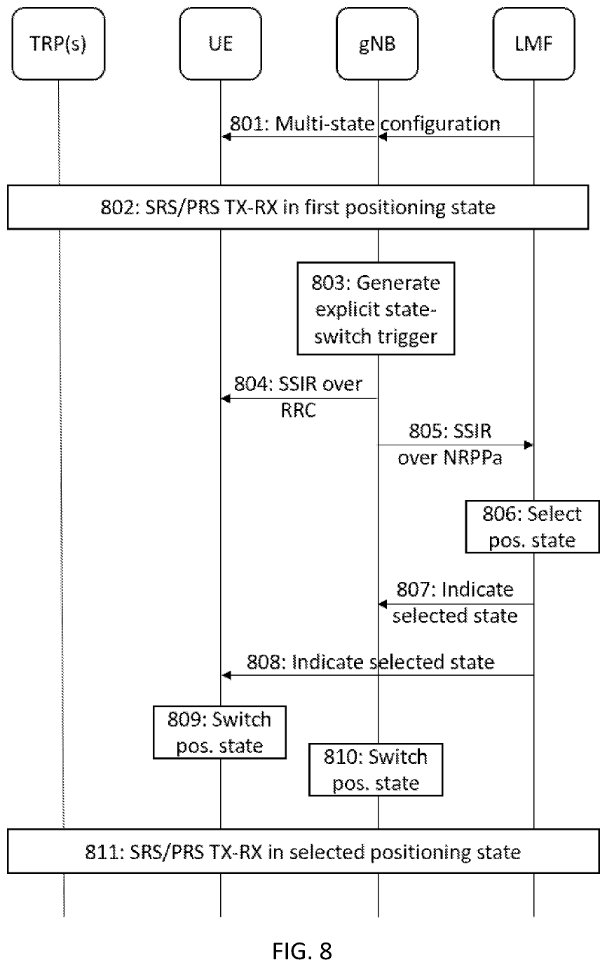

FIG. 8 illustrates a signaling diagram for a positioning session according to an exemplary embodiment, wherein the base station generates the explicit state-switch trigger, and transmits an SSIR to the LMF. In other words, the base station is the receiver of the positioning signal in this case.

Referring to FIG. 8, in step 801, the LMF transmits, to a gNB, via an NRPPa interface, a message indicative of a multi-state configuration for pre-configuring a multi-state positioning session, wherein multi-state refers to the various alternatives (i.e., states) of how the positioning signal (e.g., SRS-P in UL) can be transmitted over the wireless channel, and/or received and measured by the positioning receiver. The LMF may also transmit the multi-state configuration to a UE (directly or via the gNB). The UE is the transmitter of the positioning signal in this case. The UE may be, for example, an asset-tracking device.

For example, the LMF may configure at least two different positioning states in the multi-state configuration: a first positioning state called “position_fix”, and a second positioning state called “position_tracking”. The multi-state configuration may define one or more conditions for switching between positioning states. For example, in this exemplary embodiment, the one or more conditions may be fulfilled, when RSRP variation of the UE is above a first threshold, and/or TA variation of the UE is above a second threshold. The multi-state configuration may further indicate the gNB to request and implement a positioning state switch, when the one or more conditions are fulfilled.

In step 802, the UE and the serving gNB may perform SRS-P or PRS transmission, reception and reporting in the first positioning state, i.e., the “position_fix” state. For example, the UE may transmit SRS-P to the gNB in the uplink according to the configuration of the first positioning state, and the gNB may measure the received SRS-P according to the configuration of the first positioning state.

In step 803, the gNB generates an explicit positioning state switch trigger, if the one or more conditions are fulfilled.

In step 804, the gNB transmits an SSIR to the UE in an RRC message or in a MAC CE. In case the UE rejects the SSIR from the gNB (e.g., due to low UE power), then the UE may propose, or indicate, an alternative positioning state to the gNB and/or the LMF for the positioning state switch.

In step 805, the gNB transmits the SSIR to the LMF in an NRPPa message. The SSIR may comprise a preferred state index, or a set of multiple preferred states indices ordered by priority. For example, the SSIR may comprise at least an index associated with the second positioning state (i.e., the “position_tracking” state) in order to request a switch to the second positioning state. The SSIR may comprise a request for a full-state transition (i.e., switching the positioning state at both the transmitter and receiver) or a semi-state transition (i.e., switching the positioning state at the receiver, but not at the transmitter).

In step 806, in case the SSIR contains an ordered set of preferred state indices, the LMF may assess the request, and select one state from the set of preferred indices. In step 807, the LMF indicates the selected positioning state to the gNB via NRPPa. In step 808, the LMF indicates the selected positioning state to the UE directly or via the gNB.

In step 809, the UE may switch to the positioning state indicated by the LMF and/or the SSIR. In step 810, the gNB switches to the positioning state indicated by the LMF and/or the SSIR. If the gNB requests a full-state transition in the SSIR, then both the transmission and reception of the positioning signal (i.e., both the UE and the gNB) may switch to the configuration associated with the selected positioning state. If the gNB requests a semi-state transition in the SSIR, then the measurement acquisition at the receiver side (i.e., at the gNB in this case) is switched to the selected positioning state, but the configuration at the transmitter side (i.e., at the UE in this case) does not need to be changed.

In step 811, the UE and/or the gNB may perform SRS-P or PRS transmission, reception and reporting in the selected positioning state, for example the second positioning state (the “position_tracking” state). For example, the UE may transmit SRS-P to the gNB in the uplink according to the configuration of the selected positioning state, and/or the gNB may measure the received SRS-P according to the configuration of the selected positioning state.

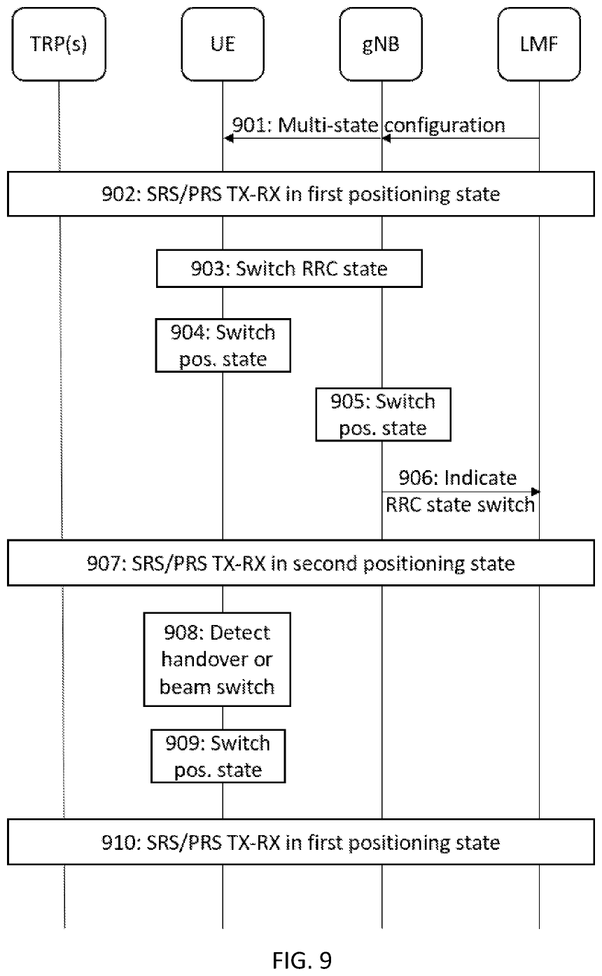

FIG. 9 illustrates a signaling diagram for a positioning session according to another exemplary embodiment, wherein a UE generates an implicit state-switch trigger. If an implicit trigger is used, then the UE and/or network may autonomously determine to switch the positioning state based on a corresponding behavior of the UE.

Referring to FIG. 9, in step 901, the LMF transmits, to a UE, a message indicative of a multi-state configuration for pre-configuring a multi-state positioning session, wherein multi-state refers to the various alternatives (i.e., states) of how the positioning signals (PRS in DL and SRS-P in UL) can be transmitted over the wireless channel, or received and measured by the positioning receiver. The UE may be, for example, an asset-tracking device. The LMF may also transmit the multi-state configuration to the serving base station (e.g., gNB) of the UE.

For example, the LMF may configure at least two different positioning states in the multi-state configuration: a first positioning state called “position_fix”, and a second positioning state called “position_tracking”. The multi-state configuration may define one or more conditions for switching between positioning states. For example, in this exemplary embodiment, the one or more conditions may be fulfilled by an RRC state switch, a handover, or a beam switch.

In step 902, the UE and the serving gNB may perform SRS-P or PRS transmission, reception and reporting in the first positioning state, i.e., the “position_fix” state. For example, the UE may transmit an SRS-P to the gNB in the uplink according to the configuration of the first positioning state, and the gNB may then measure the received SRS-P according to the configuration of the first positioning state. Alternatively, the gNB may transmit a PRS to the UE in the downlink via one or more TRPs according to the configuration of the first positioning state, and the UE may then measure the received PRS and report the measurements to the gNB according to the configuration of the first positioning state.

In step 903, an implicit positioning state switch trigger may be generated based on switching of an RRC state. For example, the implicit trigger may be the UE transitioning from RRC connected state to RRC inactive state. Thus, in step 904, the UE implicitly determines to switch the positioning state based on the RRC state switch. For example, the UE may switch from the first positioning state (“position_fix” state) to the second positioning state (“position_tracking” state), when it switches from RRC connected state to RRC inactive state.

The network (gNB) and the UE both know that the RRC state has changed. Thus, in step 905, the gNB may also implicitly determine to switch the positioning state based on the RRC state switch of the UE. For example, the gNB may switch from the first positioning state (“position_fix” state) to the second positioning state (“position_tracking” state), when the UE switches from RRC connected state to RRC inactive state.

In step 906, the gNB may indicate the RRC state switch of the UE to the LMF. Thus, the LMF may also implicitly determine, based on the RRC state switch of the UE, that the positioning state of the UE has switched.

In step 907, the UE and the gNB may perform SRS-P or PRS transmission, reception and reporting in the second positioning state, i.e., the “position_tracking” state. For example, the UE may transmit SRS-P to the gNB in the uplink according to the configuration of the second positioning state, and the gNB may then measure the received SRS-P according to the configuration of the second positioning state. Alternatively, the gNB may transmit PRS to the UE in the downlink according to the configuration of the second positioning state, and the UE may then measure the received PRS and report the measurements to the gNB according to the configuration of the second positioning state.

Similarly, the UE may switch the positioning state, when the UE experiences a handover or a beam switch. In step 908, the UE detects a handover or a beam switch. In step 909, the UE switches the positioning state based on the detected handover or beam switch. For example, the UE may switch from the second positioning state (“position_tracking” state) to the first positioning state (“position_fix” state) in step 909.

The gNB may also implicitly determine to switch the positioning state based on the handover or the beam switch associated with the UE. However, if a handover is performed, then the serving gNB of the UE may change, and the new serving gNB may then use the same positioning state as the UE (e.g., the first positioning state).

In step 910, the UE and the gNB (or the new gNB, if a handover is performed) may perform SRS-P or PRS transmission, reception and reporting in the first positioning state, i.e., the “position_fix” state. For example, the UE may transmit SRS-P to the gNB in the uplink according to the configuration of the first positioning state, and the gNB may then measure the received SRS-P according to the configuration of the first positioning state. Alternatively, the gNB may transmit PRS to the UE in the downlink according to the configuration of the first positioning state, and the UE may then measure the received PRS and report the measurements to the gNB according to the configuration of the first positioning state.

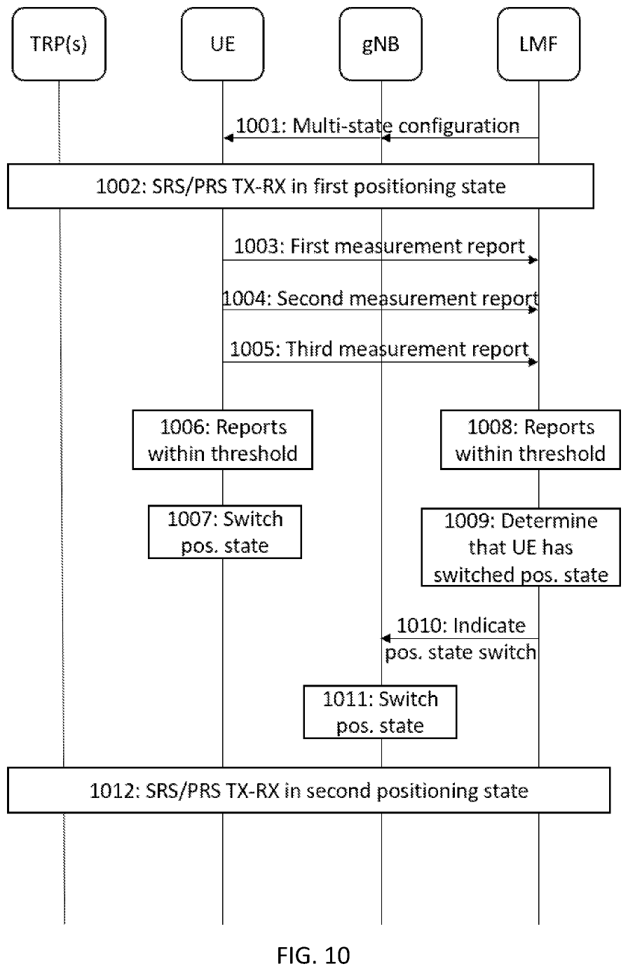

FIG. 10 illustrates a signaling diagram for a positioning session according to another exemplary embodiment, wherein a UE generates an implicit state-switch trigger. In this exemplary embodiment, the LMF indicates to the UE, for example in the multi-state configuration, that if the difference between two or more consecutive positioning measurements is within a defined threshold, then the UE should switch to a certain positioning state. For example, a switch to the “position_tracking” state may be triggered, if two or more consecutive positioning measurements do not change substantially (i.e., the difference is below or equal the threshold). As another example, a switch to the “position_fix” state may be triggered, if two or more consecutive positioning measurements change significantly (i.e., the difference is above the threshold). The LMF may implicitly determine that the UE has switched the positioning state based on the difference between the positioning measurement reports received from the UE. The threshold may depend on the target positioning accuracy. The positioning measurement may refer to, for example, reference signal time difference (RSTD), angle of arrival (AoA), or any other positioning measurement.

Referring to FIG. 10, in step 1001, the LMF transmits, to a UE, a message indicative of a multi-state configuration for pre-configuring a multi-state positioning session, wherein multi-state refers to the various alternatives (i.e., states) of how the positioning signals (PRS in DL and SRS-P in UL) can be transmitted over the wireless channel, or received and measured by the positioning receiver. The UE may be, for example, an asset-tracking device. The LMF may also transmit the multi-state configuration to the serving base station (e.g., gNB) of the UE.

For example, the LMF may configure at least two different positioning states in the multi-state configuration: a first positioning state called “position_fix”, and a second positioning state called “position_tracking”. The multi-state configuration may define one or more conditions for switching between positioning states. For example, in this exemplary embodiment, the one or more conditions for switching to the second state may be fulfilled, if the difference between two or more positioning measurements (e.g., three measurements) is below or equal to a threshold. The one or more conditions for switching to the first state may be fulfilled, if the difference between two or more positioning measurements (e.g., three measurements) is above the threshold. The threshold value may be comprised in the multi-state configuration.

In step 1002, the UE and the serving gNB may perform SRS-P or PRS transmission, reception and reporting in the first positioning state, i.e., the “position_fix” state. For example, the UE may transmit an SRS-P to the gNB in the uplink according to the configuration of the first positioning state, and the gNB may then measure the received SRS-P according to the configuration of the first positioning state. Alternatively, the gNB may transmit a PRS to the UE in the downlink via one or more TRPs according to the configuration of the first positioning state, and the UE may then measure the received PRS and report the measurements to the gNB according to the configuration of the first positioning state.

In step 1003, the UE measures a first positioning measurement value (e.g., a first RSTD value) for example based at least on a PRS received from the gNB, and transmits a first positioning measurement report (e.g., a first RSTD report) to the LMF indicating the first positioning measurement value.

In step 1004, the UE measures a second positioning measurement value (e.g., a second RSTD value) for example based at least on a PRS signal received from the gNB, and transmits a second positioning measurement report (e.g., a second RSTD report) to the LMF indicating the second positioning measurement value.

In step 1005, the UE measures a third positioning measurement value (e.g., a third RSTD value) for example based at least on a PRS signal received from the gNB, and transmits a third positioning measurement report (e.g., a third RSTD report) to the LMF indicating the third positioning measurement value.

The first positioning measurement report, the second positioning measurement report, and the third positioning measurement report may be measured and transmitted by the UE at different time instants. The positioning measurement reports may be transmitted to the LMF directly, or via the gNB.

In step 1006, the UE determines that the difference between the two or more positioning measurement values (e.g., the three RSTD values) is within the threshold (e.g., below or equal to the threshold). Thus, the UE implicitly determines to switch the positioning state based on a difference between the two or more positioning measurement values. In step 1007, the UE switches the positioning state based on the difference between the two or more positioning measurement values. For example, the UE may switch from the first positioning state to the second positioning state, if the two or more positioning measurement values are below or equal to the threshold.

Similarly, in step 1008, the LMF determines that the difference between the two or more positioning measurement values (e.g., the three RSTD values) are within the threshold (e.g., below or equal to the threshold). Thus, in step 1009, the LMF implicitly determines that the UE has switched the positioning state (e.g., to the second positioning state).

In step 1010, the LMF (or the UE) may indicate the positioning state switch to the gNB as an explicit indication. For example, the indication may indicate the gNB to switch to the second positioning state.

In step 1011, the gNB may switch the positioning state based on the indication received in step 1010. For example, the gNB may switch to the second positioning state.

In step 1012, the UE and/or the gNB may perform SRS-P or PRS transmission, reception and reporting in the second positioning state, i.e., the “position_tracking” state. For example, the UE may transmit SRS-P to the gNB in the uplink according to the configuration of the second positioning state, and the gNB may then measure the received SRS-P according to the configuration of the second positioning state. Alternatively, the gNB may transmit PRS to the UE in the downlink according to the configuration of the second positioning state, and the UE may then measure the received PRS and report the measurements to the gNB according to the configuration of the second positioning state.

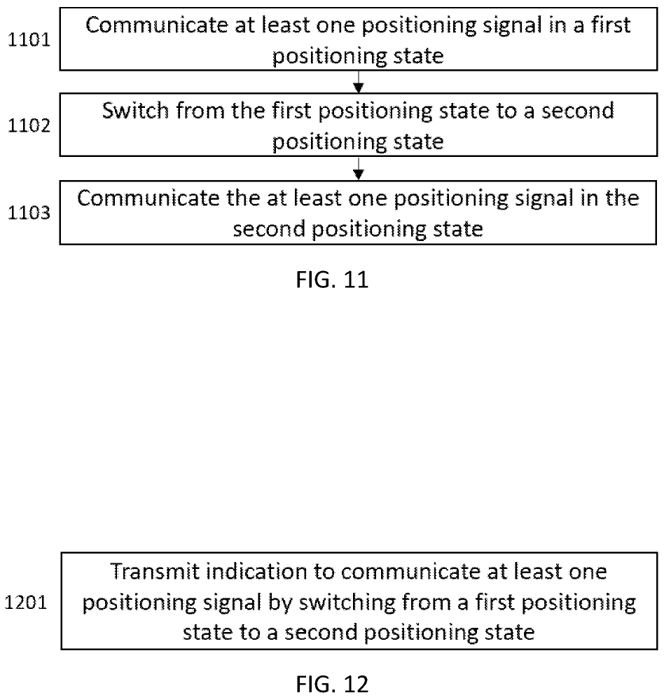

FIG. 11 illustrates a flow chart according to an exemplary embodiment. The functions illustrated in FIG. 11 may be performed by an apparatus such as, or comprised in, a terminal device or a base station. The terminal device may also be referred to as a UE, user equipment, reduced capability (RedCap) device, NR-lite device, NR-light device, low-complexity device, low-power device, or asset-tracking device herein.

Referring to FIG. 11, in step 1101, during a positioning session for positioning of the apparatus, at least one positioning signal is communicated in a first positioning state of at least two positioning states configured for the positioning session. The communicating may refer to transmitting and/or receiving the at least one positioning signal. The at least one positioning signal may comprise, for example, a positioning reference signal (PRS) and/or a sounding reference signal for positioning (SRS-P).

In step 1102, the apparatus switches from the first positioning state to a second positioning state of the at least two positioning states, wherein the first and second positioning states correspond to different reference signal configurations used for communicating of the at least one positioning signal. It should be noted that the terms ‘first’ and ‘second’ are used herein to distinguish the positioning states, and it does not mean a specific order of the positioning states. In other words, the first positioning state and the second positioning state are not necessarily consecutive states of the at least two positioning states.

In step 1103, the at least one positioning signal is communicated in the second positioning state during the positioning session.

For example, the first positioning state may refer to the “position_fix” state described above, and the second positioning state may refer to the “position_tracking” state described above. Alternatively, the first positioning state may refer to the “position_tracking” state described above, and the second positioning state may refer to the “position_fix” state described above. However, it should be noted that the first positioning state and the second positioning state are not restricted to the “position_tracking state” and the “position_fix” state, as other positioning states may also be used.

Different amount of radio resources may be utilized for communicating the at least one positioning signal in the first and second positioning states, respectively. For example, in the second positioning state (e.g., the “position_tracking” state), less radio resources may be utilized for communicating the at least one positioning signal compared to that used for communicating the at least one positioning signal in the first positioning state (e.g., the “position_fix” state).

The at least one positioning signal may be received in the second positioning state by using a different beamforming structure compared to that used for reception of the at least one positioning signal in the first positioning state. For example, in the second positioning state (e.g., the “position_tracking” state), the at least one positioning signal may be received by using a wider beamforming structure than in the first positioning state (e.g., the “position_fix” state).

The at least one positioning signal may be received in the second positioning state by using a different sampling rate compared to that used for reception of the at least one positioning signal in the first positioning state. For example, in the second positioning state (e.g., the “position_tracking” state), the at least one positioning signal may be received, or measured, by using a lower sampling rate than in the first positioning state (e.g., the “position_fix” state).

The at least one positioning signal may be received, while in the second positioning state, by measuring a different number of transmission and reception points compared to that measured for reception of the at least one positioning signal in the first positioning state. For example, in the second positioning state (e.g., the “position_tracking” state), the at least one positioning signal may be received by measuring a lower number of transmission and reception points (i.e., less TRPs) than in the first positioning state (e.g., the “position_fix” state).

The at least one positioning signal may be communicated (e.g., transmitted) in the second positioning state by using at least one of: a different number of repetitions, a different periodicity, a different bandwidth, a different comb pattern, and/or a different quantity (number) of transmission and reception points (TRPs) compared to that used for communication (e.g., transmission) of the at least one positioning signal in the first positioning state. For example, in the second positioning state (e.g., the “position_tracking” state), the at least one positioning signal may be communicated (e.g., transmitted) by using at least one of: less repetitions, a higher periodicity, a smaller bandwidth, a larger comb pattern, and/or less transmission and reception points compared to that used for communication (e.g., transmission) of the at least one positioning signal in the first positioning state (e.g., the “position_fix” state).

FIG. 12 illustrates a flow chart according to an exemplary embodiment. The functions illustrated in FIG. 12 may be performed by an apparatus such as, or comprised in, a network element of a wireless communication network. The apparatus may also be referred to, for example, as a network node, a RAN node, a NodeB, an LTE evolved NodeB (eNB), a gNB, a base station, an NR base station, a 5G base station, an access node, an access point (AP), a distributed unit (DU), a central unit (CU), a baseband unit (BBU), a radio unit (RU), a radio head, a remote radio head (RRH), a transmission and reception point (TRP), a location server, or a location management function (LMF).

Referring to FIG. 12, in step 1201, during a positioning session for positioning of a terminal device in the wireless communication network, an indication is transmitted to one or more network elements in the wireless communication network, wherein the indication indicates to communicate at least one positioning signal by switching from a first positioning state to a second positioning state of at least two positioning states configured for the positioning session, wherein the first and second positioning states correspond to different reference signal configurations used for communicating of the at least one positioning signal. The communicating may refer to transmitting and/or receiving the at least one positioning signal. The at least one positioning signal may comprise, for example, PRS and/or SRS-P. It should be noted that the terms ‘first’ and ‘second’ are used herein to distinguish the positioning states, and it does not mean a specific order of the positioning states. In other words, the first positioning state and the second positioning state are not necessarily consecutive states of the at least two positioning states.

The one or more network elements may comprise the terminal device. Alternatively or additionally, the one or more network elements may comprise, for example, a base station (if the apparatus is an LMF) or an LMF (if the apparatus is a base station).

For example, the first positioning state may refer to the “position_fix” state described above, and the second positioning state may refer to the “position_tracking” state described above. Alternatively, the first positioning state may refer to the “position_tracking” state described above, and the second positioning state may refer to the “position_fix” state described above. However, it should be noted that the first positioning state and the second positioning state are not restricted to the “position_tracking state” and the “position_fix” state, as other positioning states may also be used.

The functions and/or blocks described above by means of FIGS. 3-12 are in no absolute chronological order, and some of them may be performed simultaneously or in an order differing from the described one. Other functions and/or blocks may also be executed between them or within them.

A technical advantage provided by some exemplary embodiments is that they may increase spectral efficiency and reduce the UE power consumption associated with processing incoming positioning signals. In addition, some exemplary embodiments may reduce latency by enabling a flexible reconfiguration, for example by reducing the frequency (rate) of transmitting measurement gap requests. Some exemplary may enable more accurate positioning for low-complexity (e.g., low-power) devices. Moreover, some exemplary embodiments may enable positioning in RRC inactive or idle state.

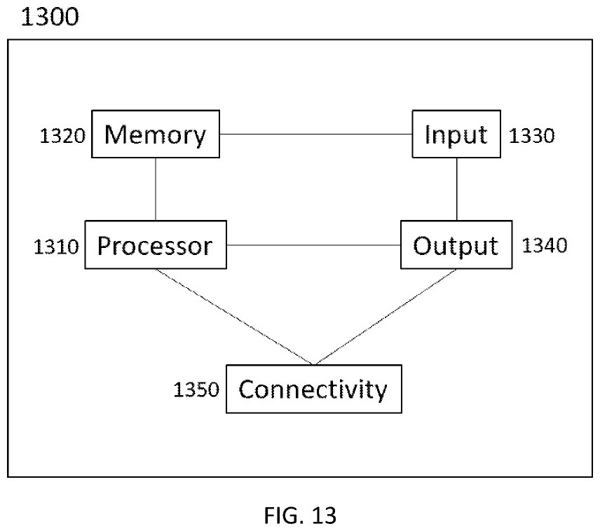

FIG. 13 illustrates an apparatus 1300, which may be an apparatus such as, or comprised in, a terminal device, according to an exemplary embodiment. The terminal device may also be referred to as a UE, user equipment, reduced capability (RedCap) device, NR-lite device, NR-light device, low-complexity device, low-power device, or asset-tracking device herein. The apparatus 1300 comprises a processor 1310. The processor 1310 interprets computer program instructions and processes data. The processor 1310 may comprise one or more programmable processors. The processor 1310 may comprise programmable hardware with embedded firmware and may, alternatively or additionally, comprise one or more application-specific integrated circuits (ASICs).

The processor 1310 is coupled to a memory 1320. The processor is configured to read and write data to and from the memory 1320. The memory 1320 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1320 stores computer readable instructions that are executed by the processor 1310. For example, non-volatile memory stores the computer readable instructions and the processor 1310 executes the instructions using volatile memory for temporary storage of data and/or instructions.

The computer readable instructions may have been pre-stored to the memory 1320 or, alternatively or additionally, they may be received, by the apparatus, via an electromagnetic carrier signal and/or may be copied from a physical entity such as a computer program product. Execution of the computer readable instructions causes the apparatus 1300 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 1300 may further comprise, or be connected to, an input unit 1330. The input unit 1330 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1330 may comprise an interface to which external devices may connect to.

The apparatus 1300 may also comprise an output unit 1340. The output unit may comprise or be connected to one or more displays capable of rendering visual content, such as a light emitting diode (LED) display, a liquid crystal display (LCD) and/or a liquid crystal on silicon (LCoS) display. The output unit 1340 may further comprise one or more audio outputs. The one or more audio outputs may be for example loudspeakers.

The apparatus 1300 further comprises a connectivity unit 1350. The connectivity unit 1350 enables wireless connectivity to one or more external devices. The connectivity unit 1350 comprises at least one transmitter and at least one receiver that may be integrated to the apparatus 1300 or that the apparatus 1300 may be connected to. The at least one transmitter comprises at least one transmission antenna, and the at least one receiver comprises at least one receiving antenna. The connectivity unit 1350 may comprise an integrated circuit or a set of integrated circuits that provide the wireless communication capability for the apparatus 1300. Alternatively, the wireless connectivity may be a hardwired application-specific integrated circuit (ASIC). The connectivity unit 1350 may comprise one or more components such as a power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 1300 may further comprise various components not illustrated in FIG. 13. The various components may be hardware components and/or software components.

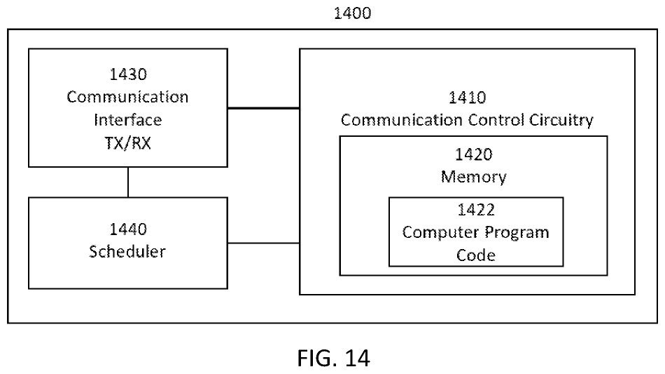

The apparatus 1400 of FIG. 14 illustrates an exemplary embodiment of an apparatus such as, or comprised in, a network element of a wireless communication network. The network element may also be referred to, for example, as a network node, a RAN node, a NodeB, an LTE evolved NodeB (eNB), a gNB, a base station, an NR base station, a 5G base station, an access node, an access point (AP), a distributed unit (DU), a central unit (CU), a baseband unit (BBU), a radio unit (RU), a radio head, a remote radio head (RRH), a transmission and reception point (TRP), a location server, or a location management function (LMF). The apparatus may comprise, for example, a circuitry or a chipset applicable to realizing some of the described exemplary embodiments. The apparatus 1400 may be an electronic device comprising one or more electronic circuitries. The apparatus 1400 may comprise a communication control circuitry 1410 such as at least one processor, and at least one memory 1420 including a computer program code (software) 1422 wherein the at least one memory and the computer program code (software) 1422 are configured, with the at least one processor, to cause the apparatus 1400 to carry out some of the exemplary embodiments described above.

The processor is coupled to the memory 1420. The processor is configured to read and write data to and from the memory 1420. The memory 1420 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1420 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1420 or, alternatively or additionally, they may be received, by the apparatus, via an electromagnetic carrier signal and/or may be copied from a physical entity such as a computer program product. Execution of the computer readable instructions causes the apparatus 1400 to perform one or more of the functionalities described above.

The memory 1420 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some exemplary embodiments, structures of the frames used in the detected neighbour cells.

The apparatus 1400 may further comprise a communication interface 1430 comprising hardware and/or software for realizing communication connectivity according to one or more communication protocols. The communication interface 1430 comprises at least one transmitter (TX) and at least one receiver (RX) that may be integrated to the apparatus 1400 or that the apparatus 1400 may be connected to. The communication interface 1430 provides the apparatus with radio communication capabilities to communicate in the cellular communication system. The communication interface may, for example, provide a radio interface to terminal devices. The apparatus 1400 may further comprise another interface towards a core network such as the network coordinator apparatus and/or to the access nodes of the cellular communication system. The apparatus 1400 may further comprise a scheduler 1440 that is configured to allocate resources.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s)), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1. An apparatus in a wireless communication network, the apparatus comprising at least one processor, and at least one memory including computer program code, wherein the at least one memory and the computer program code are configured, with the at least one processor, to cause the apparatus to:
communicate, during a positioning session for positioning of the apparatus, at least one first positioning signal in a first positioning state of at least two positioning states configured for the positioning session;
switch from the first positioning state to a second positioning state of the at least two positioning states, wherein the first and second positioning states correspond to different reference signal configurations used for communicating the at least one positioning signal; and
communicate at least one second positioning signal in the second positioning state during the positioning session.

2. The apparatus according to claim 1, wherein different amount of radio resources are utilized for communicating the at least one first positioning signal and the at least one second positioning signal in the first and second positioning states, respectively.

3. The apparatus according to claim 1, wherein the at least one second positioning signal is received in the second positioning state by using a different beamforming structure compared to that used for reception of the at least one first positioning signal in the first positioning state.

4. The apparatus according to claim 1, wherein the at least one second positioning signal is received in the second positioning state by using a different sampling rate compared to that used for reception of the at least one first positioning signal in the first positioning state.

5. The apparatus according to claim 1, wherein the at least one second positioning signal is received in the second positioning state by measuring a different number of transmission and reception points compared to that measured for reception of the at least one first positioning signal in the first positioning state.

6. The apparatus according to claim 1, wherein the at least one second positioning signal is communicated in the second positioning state by using at least one of: a different number of repetitions, a different periodicity, a different bandwidth, a different comb pattern, and/or a different quantity of transmission and reception points compared to that used for communication of the at least one first positioning signal in the first positioning state.

7. The apparatus according to claim 1, wherein the apparatus is further caused to:
receive a message indicative of a configuration for the at least two positioning states,
wherein the configuration comprises one or more conditions for switching to the second positioning state from the first positioning state during the positioning session.

8. The apparatus according to claim 7, wherein the apparatus is further caused to:
determine that the one or more conditions are fulfilled based at least partly on at least one of: a mobility status of the apparatus, a radio resource control state of the apparatus, one or more quality of service requirements of the apparatus, a battery life of the apparatus, a handover experienced by the apparatus, a beam switch experienced by the apparatus, a reference signal received power variation, and/or a timing advance variation.

9. The apparatus according to claim 8, wherein the apparatus is further caused to:
in accordance with a determination that the one or more conditions are fulfilled, transmit, to one or more network elements in the wireless communication network, a request for the switching from the first positioning state to the second positioning state during the positioning session.

10. The apparatus according to claim 9, wherein the one or more network elements comprise at least a base station and a location management function,
wherein the request is transmitted to the base station in a radio resource control message, and/or
wherein the request is transmitted to the location management function in a long term evolution positioning protocol (LPP) message.

11. The apparatus according to claim 9, wherein the request comprises a set of indices associated with a plurality of positioning states ordered by priority, wherein the set of indices comprises at least an index associated with the second positioning state.

12. The apparatus according to claim 1, wherein the apparatus is further caused to:
indicate, to one or more network elements of a wireless communication network, the switch to the second positioning state during the positioning session by transmitting two or more positioning measurement reports,
wherein the switch to the second positioning state during the positioning session is based on a difference between the two or more positioning measurement reports.

13. The apparatus according to claim 1, wherein the apparatus is further caused to:
receive an indication indicating to switch from the first positioning state to the second positioning state during the positioning session.

14. The apparatus according to claim 1, wherein the apparatus comprises, or is comprised in, a terminal device.

15. An apparatus in a wireless communication network, the apparatus comprising at least one processor, and at least one memory including computer program code, wherein the at least one memory and the computer program code are configured, with the at least one processor, to cause the apparatus to:
transmit, during a positioning session for positioning of a terminal device in the wireless communication network, to one or more network elements in the wireless communication network, an indication to communicate at least one positioning signal by switching from a first positioning state to a second positioning state of at least two positioning states configured for the positioning session, wherein the first and second positioning states correspond to different reference signal configurations used for communicating of the at least one positioning signal.

16. The apparatus according to claim 15, wherein different amount of radio resources are utilized for communicating the at least one positioning signal in the first and second positioning states, respectively.

17. The apparatus according to claim 15, wherein the second positioning state indicates to transmit the at least one positioning signal by using at least one of: a different number of repetitions, a different periodicity, a different bandwidth, a different comb pattern, and/or a different number of transmission and reception points compared to that used for transmission of the at least one positioning signal in the first positioning state.

18. The apparatus according to claim 15, wherein the apparatus is further caused to:
transmit a message indicative of a configuration for the at least two positioning states, wherein the configuration comprises one or more conditions for switching between the at least two positioning states for communicating of the at least one positioning signal.

19. The apparatus according to claim 15, wherein the apparatus is further caused to:
determine to transmit the indication based at least partly on at least one of: a change in a mobility status of the terminal device, a change of a radio resource control state of the terminal device, one or more quality of service requirements of the terminal device, a battery life of the terminal device, a handover associated with the terminal device, and/or a beam switch associated with the terminal device,
wherein the indication to switch to the second positioning state is transmitted in response to the determining.

20. The apparatus according to claim 19, wherein the apparatus is further caused to:
determine the change in the mobility status of the terminal device based at least partly on at least one of: a change in a reference signal received power metric, a change in a received signal strength indicator metric, a change in a channel quality indicator metric, a change in a timing advance metric, a change of a serving beam index, and/or a change in a maximum Doppler shift estimate.

21.-38. (canceled)
